(19) United States
(12) Patent Application Publication
(10) Pub. No.: US 2026/0290825 A1
(43) Pub. Date: Sep. 24, 2026

(54) NEGATIVE ELECTRODE MATERIAL AND PREPARATION METHOD THEREFOR, ELECTROCHEMICAL DEVICE, AND ELECTRONIC DEVICE

(71) Applicant: Ningde Amperex Technology Limited, Ningde (CN)

(72) Inventors: Wenchen REN, Ningde (CN); Lijuan ZHANG, Ningde (CN)

(73) Assignee: Ningde Amperex Technology Limited, Ningde (CN)

(21) Appl. No.: 19/571,629

(22) Filed: Mar. 19, 2026

(30) Foreign Application Priority Data
Mar. 24, 2025 (CN) 202510352296.1

(51) Int. Cl. H01M 4/587; H01G 11/28; H01G 11/32; H01G 11/62; H01M 4/02; H01M 10/0525; H01M 10/0568; H01M 10/0569

(52) U.S. Cl. CPC H01M 4/587; H01M 10/0525; H01M 10/0568; H01M 10/0569; H01G 11/28; H01G 11/32; H01G 11/62; H01M 2004/021; H01M 2004/027; H01M 2300/0034; H01M 2300/0037

(57) ABSTRACT

A negative electrode material includes silicon-carbon particles, where the silicon-carbon particles include a first region and a second region. The first region is a region from the surface of the silicon-carbon particles to a depth of 40 nm therefrom; and the second region is a region from a depth of 60 nm from the surface of the silicon-carbon particles to a depth of 100 nm therefrom. The silicon-carbon particles contain a silicon element and a carbon element. Based on a total number of atoms of the silicon element and the carbon element in the first region, an atomic percentage of the silicon element in the first region ranges from 9.4 to 36.7; and based on the total number of atoms of the silicon element and the carbon element in the second region, an atomic percentage of the silicon element in the second region ranges from 23.8 to 31.8.

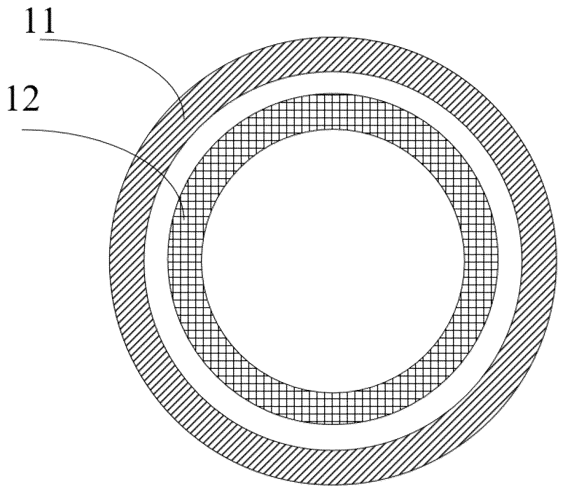

### CROSS-REFERENCE TO RELATED APPLICATION

The present application claims priority to Chinese Patent application No. 202510352296.1 filed in the China National Intellectual Property Administration on Mar. 24, 2025, the entire content of which is hereby incorporated by reference.

### TECHNICAL FIELD

This application relates to the field of electrochemical technologies, and in particular to a negative electrode material and a preparation method therefor, an electrochemical device, and an electronic device.

### BACKGROUND

As a negative electrode material for conventional commercial lithium-ion batteries, graphite has a low capacity (372 mAh/g) and poses a safety hazard of lithium dendrites. These limitations restrict its further application. Consequently, developing negative electrode materials for lithium-ion batteries with high energy density and high safety has become a focus of current technological development. Compared with carbon-based materials such as graphite, silicon materials are considered one of the most promising alternatives to graphite due to their ultra-high theoretical specific capacity and suitable operating voltage.

However, silicon materials used as negative electrode materials are prone to excessive expansion rates during charging, which leads to a decline in the cycling performance of lithium-ion batteries. One of the main reasons for the above problem is the uneven distribution of the silicon element in the silicon material particles: regions with high silicon concentration exhibit larger expansion rates after lithium intercalation, while regions with low silicon concentration exhibit relatively smaller expansion rates after lithium intercalation. This unevenness results in uneven distribution of lithium intercalation stress inside the silicon material particles, ultimately causing excessive expansion or even cracking of the silicon material particles, thereby affecting the cycling and expansion performance of lithium-ion batteries. Solving these problems is crucial for improving the performance of lithium-ion batteries.

### SUMMARY

The purpose of this application is to provide a negative electrode material and a preparation method therefor, an electrochemical device, and an electronic device, so as to improve the fast-charging performance and room-temperature storage performance of the electrochemical device and ameliorate lithium precipitation at the negative electrode.

It should be noted that in the summary of this application, lithium-ion batteries are used as examples of electrochemical devices to explain this application, but the electrochemical device of this application is not limited to lithium-ion batteries. The specific technical solutions are as follows:

In a first aspect, this application provides a negative electrode material. The negative electrode material includes silicon-carbon particles, and the silicon-carbon particles include a first region and a second region, the first region being a region from the surface of the silicon-carbon particles to a depth of 40 nm from the surface of the silicon-carbon particles; the second region being a region from a depth of 60 nm from the surface of the silicon-carbon particles to a depth of 100 nm from the surface of the silicon-carbon particles. The silicon-carbon particles contain a silicon element and a carbon element. Based on a total number of atoms of the silicon element and the carbon element in the first region, an atomic percentage of the silicon element in the first region is A %, where 19.4≤A≤36.7; and based on the total number of atoms of the silicon element and the carbon element in the second region, an atomic percentage of the silicon element in the second region is B %, where 23.8≤B≤31.8. By regulating the values of A and B within the above ranges, the gram capacity of the silicon-carbon particles can be increased and the expansion of the silicon-carbon particles during cycling can be reduced. In addition, the lithiation stress is more uniformly distributed throughout the silicon-carbon particles, reducing the risk of lithium ion aggregation forming lithium dendrites due to excessively high local silicon element content, ameliorating lithium precipitation at the negative electrode, and improving the fast-charging performance and room-temperature storage performance of the electrochemical device.

In one embodiment of this application, 0.66≤B/A≤1.58. When the value of B/A is within the above range, lithium precipitation at the negative electrode can be ameliorated, and the fast-charging performance and room-temperature storage performance of the electrochemical device can be further improved.

In one embodiment of this application, 0.82≤B/A≤1.29. When the value of B/A is within the above range, lithium precipitation at the negative electrode can be further ameliorated, and the fast-charging performance and room-temperature storage performance of the electrochemical device can be further improved.

In one embodiment of this application, the silicon-carbon particles have an average particle diameter D₁ of 5.5 μm to 8.7 μm. By regulating the average particle diameter D₁ of the silicon-carbon particles within the above range, the lithium intercalation capability of the silicon-carbon particles can be improved, and the expansion performance and cycling performance of the electrochemical device can be enhanced. In addition, the transport efficiency of lithium ions can be increased, the kinetic performance of the electrochemical device can be improved, and lithium precipitation at the negative electrode can be ameliorated.

In one embodiment of this application, the silicon-carbon particles have a powder resistivity ρ of 0.25 Ω·cm to 8.7 Ω·cm. When ρ is within the above range, the electron transport speed in the negative electrode material layer can be increased, the internal resistance of the electrochemical device can be reduced, and the utilization rate of the negative electrode active material can be improved, thereby enhancing the fast-charging performance of the electrochemical device.

In a second aspect, this application provides a method for preparing the negative electrode material in any of the foregoing embodiments. The preparation method of the silicon-carbon particles includes the following steps: (1) providing a porous carbon matrix, subjecting the porous carbon matrix to a first heat-preserving treatment under an inert atmosphere, and then introducing a silane-containing gas to obtain a first intermediate; where the temperature T₁ of the first heat-preserving treatment is in the range of 380° C. to 460° C., the duration t₁ of the first heat-preserving treatment is in the range of 1 h to 3 h; the duration t₂ of introducing the silane-containing gas is in the range of 400 min to 1600 min; the flow rate V₁ of the silane-containing gas is in the range of 0.5 L/min to 2 L/min; the silane-containing gas includes at least one selected from the group consisting of methylsilane, ethylsilane, propylsilane, phenylsilane, and tolylsilane; (2) subjecting the first intermediate to a second heat-preserving treatment under an inert atmosphere, and then introducing a first compound to obtain the silicon-carbon particles; where the temperature T₂ of the second heat-preserving treatment is in the range of 480° C. to 600° C., the duration t₃ of the second heat-preserving treatment is in the range of 0.5 h to 2 h; the duration ta of introducing the first compound is in the range of 120 min to 420 min; the flow rate V₂ of the first compound is in the range of 3 L/min to 10 L/min; the first compound includes at least one selected from the group consisting of acetylene, propylene, and toluene. By regulating the preparation parameters within the above ranges, when the prepared negative electrode material is applied in an electrochemical device, the fast-charging performance and room-temperature storage performance of the electrochemical device can be improved, and lithium precipitation at the negative electrode can be ameliorated.

In a third aspect, this application provides an electrochemical device. The electrochemical device includes a negative electrode plate and an electrolyte, the negative electrode plate includes a negative electrode current collector and a negative electrode material layer provided on at least one surface of the negative electrode current collector, and the negative electrode material layer includes the negative electrode material in any of the foregoing embodiments. The electrochemical device of this application has good fast-charging performance and room-temperature storage performance, and lithium precipitation at the negative electrode is ameliorated.

In one embodiment of this application, the negative electrode material layer has a compacted density F g/cm³, where 1.65≤F≤1.79, preferably 1.73≤F≤1.79. When the value of F is within the above range, the negative electrode material layer has an appropriate thickness and porosity, improving the energy density and fast-charging performance of the electrochemical device.

In one embodiment of this application, the negative electrode material layer has a thickness D₂ of 32 μm to 66 μm. When the thickness D₂ of the negative electrode material layer is within the above range, the energy density of the electrochemical device can be increased. In addition, the transport distance of ions and electrons in the negative electrode material layer can be shortened, and the sheet resistance of the negative electrode plate can be reduced, thereby improving the fast-charging performance of the electrochemical device.

In one embodiment of this application, the negative electrode plate has a sheet resistance R of 9.2 Ω·cm to 28.7 Ω·cm. When the sheet resistance R of the negative electrode plate is within the above range, the conductivity of the negative electrode plate can be improved, enhancing the cycling performance of the electrochemical device.

In one embodiment of this application, the electrolyte includes lithium difluorophosphate, and based on a mass of the electrolyte, a mass percentage of lithium difluorophosphate is G %, where 0.01≤G≤2, preferably 0.05≤G≤0.95. When G is within the above range, side reactions between the electrolyte and the negative electrode material can be reduced, thereby improving the cycling performance of the electrochemical device and prolonging the cycle life of the electrochemical device.

In one embodiment of this application, the electrolyte includes fluoroethylene carbonate, and based on a mass of the electrolyte, a mass percentage of fluoroethylene carbonate is E %, where 7≤E≤20, preferably 10≤E≤15. When E is within the above range, side reactions between the electrolyte and the negative electrode material can be reduced, thereby improving the cycling performance of the electrochemical device and prolonging the cycle life of the electrochemical device.

In one embodiment of this application, the electrolyte includes vinylene carbonate, and based on a mass of the electrolyte, a mass percentage of vinylene carbonate is H %, where 0.01≤H≤2, preferably 0.01≤H≤0.85. When His within the above range, side reactions between the negative electrode material and the electrolyte can be effectively reduced, thereby improving the stability of the negative electrode material and prolonging the cycle life of the electrochemical device.

In one embodiment of this application, the electrolyte includes fluoroethylene carbonate, and based on a mass of the electrolyte, a mass percentage of fluoroethylene carbonate is E %, where 1.6≤A/E≤2.9. When the value of A/E is within the above range, side reactions between the negative electrode material and the electrolyte can be effectively reduced, protecting the negative electrode material and prolonging the cycle life of the electrochemical device.

In a fourth aspect, this application provides an electronic device. The electronic device includes the electrochemical device in any of the foregoing embodiments. The electronic device of this application has good performance in use.

### Beneficial Effects of this Application

This application provides a negative electrode material and a preparation method therefor, an electrochemical device, and an electronic device. The negative electrode material includes silicon-carbon particles, and the silicon-carbon particles include a first region and a second region, the first region being a region from the surface of the silicon-carbon particles to a depth of 40 nm from the surface of the silicon-carbon particles; the second region being a region from a depth of 60 nm from the surface of the silicon-carbon particles to a depth of 100 nm from the surface of the silicon-carbon particles. The silicon-carbon particles contain a silicon element and a carbon element. Based on a total number of atoms of the silicon element and the carbon element in the first region, an atomic percentage of the silicon element in the first region is A %, where 19.4≤A≤36.7; and based on the total number of atoms of the silicon element and the carbon element in the second region, an atomic percentage of the silicon element in the second region is B %, where 23.8≤B≤31.8. By regulating the values of A and B within the scope of this application, the fast-charging performance and room-temperature storage performance of the electrochemical device can be improved, and lithium precipitation at the negative electrode can be ameliorated.

Certainly, it is not necessary for any product or method implementing this application to simultaneously achieve all of the advantages described above.

### BRIEF DESCRIPTION OF DRAWINGS

In order to more clearly illustrate the embodiments of this application or the technical solutions in the prior art, the drawings required for use in the description of the embodiments or the prior art will be briefly introduced below. Obviously, the drawings in the following description are merely some embodiments of this application, and for a person of ordinary skill in the art, other embodiments may also be obtained according to these drawings.

The FIGURE is a schematic structural diagram of silicon-carbon particles according to an embodiment of this application.

### DESCRIPTION OF EMBODIMENTS

The technical solutions in the embodiments of this application will be clearly and completely described below in conjunction with the embodiments and drawings of this application. Obviously, the described embodiments are merely a part of the embodiments of this application, rather than all of the embodiments. All other embodiments obtained by a person of ordinary skill in the art based on this application fall within the protection scope of this application.

It should be noted that in the embodiments of this application, lithium-ion batteries are used as examples of electrochemical devices to explain this application, but the electrochemical device of this application is not limited to lithium-ion batteries.

In a first aspect, this application provides a negative electrode material. The negative electrode material includes silicon-carbon particles, and the silicon-carbon particles include a first region and a second region, as shown in the FIGURE, the first region 11 being a region from the surface of the silicon-carbon particles to a depth of 40 nm from the surface of the silicon-carbon particles; the second region 12 being a region from a depth of 60 nm from the surface of the silicon-carbon particles to a depth of 100 nm from the surface of the silicon-carbon particles. The silicon-carbon particles contain a silicon element and a carbon element. Based on a total number of atoms of the silicon element and the carbon element in the first region, an atomic percentage of the silicon element in the first region is A %, where 19.4≤A≤36.7; and based on the total number of atoms of the silicon element and the carbon element in the second region, an atomic percentage of the silicon element in the second region is B %, where 23.8≤B≤31.8. For example, the value of A may be 19.4, 20, 20.5, 21, 21.5, 22, 22.5, 23, 23.5, 24, 24.5, 25, 25.2, 30.1, 32.5, 36.7 or a range consisting of any two of these values; the value of B may be 23.8, 24.3, 25.8, 26.4, 27.8, 28.6, 30.6, 31.8 or a range consisting of any two of these values.

The inventors have found that when the values of A and B are too low, for example, when the value of A is lower than 19.4 and the value of B is lower than 23.8, the gram capacity of the negative electrode material is low; when the values of A and B are too high, for example, when the value of A is higher than 36.7 and the value of B is higher than 31.8, the lithium intercalation amount at the negative electrode becomes excessively large, thereby causing cracking of the silicon-carbon particles due to uneven stress distribution. By regulating the values of A and B within the above ranges, the gram capacity of the silicon-carbon particles can be increased and the expansion of the silicon-carbon particles during cycling can be reduced. In addition, the lithiation stress is more uniformly distributed throughout the silicon-carbon particles, reducing the risk of lithium ion aggregation forming lithium dendrites due to excessively high local silicon element content, ameliorating lithium precipitation at the negative electrode, and improving the fast-charging performance and room-temperature storage performance of the electrochemical device.

In one embodiment of this application, 0.66≤B/A≤1.58, preferably 0.82≤B/A≤1.29. For example, the value of B/A may be 0.66, 0.7, 0.75, 0.78, 0.8, 0.82, 0.83, 0.84, 0.85, 0.86, 0.87, 0.89, 0.91, 0.95, 1, 1.1, 1.2, 1.29, 1.35, 1.45, 1.58 or a range consisting of any two of these values. The value of B/A reflects the distribution of silicon atoms on the surface of the silicon-carbon particles. When the value of B/A is within the above range, the lithium intercalation amount in different regions of the silicon-carbon particles during charging can be relatively uniformly distributed, thereby ameliorating the phenomenon of excessive lithium intercalation amount and high stress caused by excessively high local silicon content in the silicon-carbon particles. This is beneficial to increasing the solid-phase transport rate of lithium ions inside the silicon-carbon particles, ameliorating lithium precipitation at the negative electrode, and further improving the fast-charging performance and room-temperature storage performance of the electrochemical device.

In one embodiment of this application, the silicon-carbon particles have an average particle diameter D₁ of 5.5 μm to 8.7 μm. For example, the average particle diameter D₁ of the silicon-carbon particles may be 5.5 μm, 6 μm, 6.5 μm, 7 μm, 7.5 μm, 8 μm, 8.5 μm, 8.7 μm or a range consisting of any two of these values. During charging and discharging of silicon-carbon particles, lithium ions undergo two processes: ion transport through the solid electrolyte interface (SEI) and internal solid-phase ion transport. Both the processes affect the kinetic performance and cycling performance of the lithium-ion battery. By regulating the average particle diameter D₁ of the silicon-carbon particles within the above range, the silicon-carbon particles have an appropriate specific surface area, the SEI film has an appropriate thickness. This improves the lithium intercalation capability of the silicon-carbon particles and enhances the expansion performance and cycling performance of the electrochemical device. In addition, the solid-phase transport distance of lithium ions inside the particles is short, increasing the transport efficiency of lithium ions, improving the kinetic performance of the electrochemical device, and ameliorating lithium precipitation at the negative electrode.

In one embodiment of this application, the silicon-carbon particles have a powder resistivity ρ of 0.25 Ω·cm to 8.7 Ω·cm. For example, the powder resistivity ρ of the silicon-carbon particles may be 0.25 Ω·cm, 1 Ω·cm, 2 Ω·cm, 3 Ω·cm, 4 Ω·cm, 5 Ω·cm, 6 Ω·cm, 7 Ω·cm, 8 Ω·cm, 8.7 Ω·cm or a range consisting of any two of these values. When ρ is within the above range, the electron transport speed in the negative electrode material layer can be increased, the internal resistance of the electrochemical device can be reduced, and the utilization rate of the negative electrode active material can be improved, thereby enhancing the fast-charging performance of the electrochemical device.

In one embodiment of this application, based on the mass of the silicon-carbon particles, the mass percentage of the silicon element is 43.5% to 64.2%, and the mass percentage of the carbon element is 34.8% to 55.5%.

In one embodiment of this application, the negative electrode material further includes a carbon material, and the carbon material includes at least one of artificial graphite, natural graphite, mesocarbon microbeads, hard carbon, or soft carbon. Based on the mass of the negative electrode material, the mass percentage of the silicon-carbon particles is 10% to 15%, and the mass percentage of the carbon material is 85% to 90%. For example, based on the mass of the negative electrode material, the mass percentage of the silicon-carbon particles may be 10%, 11%, 12%, 13%, 14%, 15% or a range consisting of any two of these values; based on the mass of the negative electrode material, the mass percentage of the carbon material may be 85%, 86%, 87%, 88%, 89%, 90% or a range consisting of any two of these values.

In a second aspect, this application provides a method for preparing the negative electrode material in any of the foregoing embodiments. The preparation method of the silicon-carbon particles includes the following steps: (1) providing a porous carbon matrix, subjecting the porous carbon matrix to a first heat-preserving treatment under an inert atmosphere, and then introducing a silane-containing gas to obtain a first intermediate; where the temperature T₁ of the first heat-preserving treatment is in the range of 380° C. to 460° C., the duration t₁ of the first heat-preserving treatment is in the range of 1 h to 3 h; the duration t₂ of introducing the silane-containing gas is in the range of 400 min to 1600 min; the flow rate V₁ of the silane-containing gas is in the range of 0.5 L/min to 2 L/min; the silane-containing gas includes at least one selected from the group consisting of methylsilane, ethylsilane, propylsilane, phenylsilane, and tolylsilane; (2) subjecting the first intermediate to a second heat-preserving treatment under an inert atmosphere, and then introducing a first compound to obtain the silicon-carbon particles; where the temperature T₂ of the second heat-preserving treatment is in the range of 480° C. to 600° C., the duration t₃ of the second heat-preserving treatment is in the range of 0.5 h to 2 h; the duration ta of introducing the first compound is in the range of 120 min to 420 min; the flow rate V₂ of the first compound is in the range of 3 L/min to 10 L/min; the first compound includes at least one selected from the group consisting of acetylene, propylene, and toluene. By regulating the preparation parameters within the above ranges, when the prepared negative electrode material is applied in an electrochemical device, the fast-charging performance and room-temperature storage performance of the electrochemical device can be improved, and lithium precipitation at the negative electrode can be ameliorated.

In one embodiment of this application, the negative electrode material may be obtained by uniformly mixing the silicon-carbon particles and the carbon material in a mass ratio of 10:90 to 15:85.

This application has no particular limitation on the inert atmosphere, as long as the purpose of this application can be achieved. For example, the inert atmosphere may be at least one of argon or helium.

This application has no particular limitation on the method for regulating the value of A, as long as the purpose of this application can be achieved. For example, the value of A may be regulated by regulating the temperature T₁ of the first heat-preserving treatment. Illustratively, when T₁ is increased, the value of A increases, and when T₁ is decreased, the value of A decreases.

This application has no particular limitation on the method for regulating the value of B, as long as the purpose of this application can be achieved. For example, the value of B may be regulated by regulating the flow rate V₁ of the silane-containing gas. Illustratively, when V₁ is decreased, the value of B increases, and when V₁ is increased, the value of B decreases.

This application has no particular limitation on the method for regulating the value of B/A, as long as the purpose of this application can be achieved. For example, the value of B/A may be regulated by regulating the respective values of B and A, and the regulation methods are as described above.

This application has no particular limitation on the method for regulating the average particle diameter D₁ of the silicon-carbon particles, as long as the purpose of this application can be achieved. For example, porous carbon matrices with different average particle diameters may be selected as needed to regulate the average particle diameter D₁ of the silicon-carbon particles.

This application has no particular limitation on the method for regulating the powder resistivity ρ of the silicon-carbon particles, as long as the purpose of this application can be achieved. For example, the temperature T₁ of the first heat-preserving treatment, the duration t₂ of introducing the silane-containing gas, the flow rate V₁ of the silane-containing gas, or the flow rate V₂ of the first compound may affect the powder resistivity ρ of the silicon-carbon particles.

In a third aspect, this application provides an electrochemical device. The electrochemical device includes a negative electrode plate and an electrolyte. The negative electrode plate includes a negative electrode current collector and a negative electrode material layer provided on at least one surface of the negative electrode current collector, and the negative electrode material layer includes the negative electrode material in any of the foregoing embodiments. The electrochemical device of this application has good fast-charging performance and room-temperature storage performance, and lithium precipitation at the negative electrode is ameliorated.

In one embodiment of this application, the negative electrode material layer has a compacted density F g/cm³, where 1.65≤F≤1.79, preferably 1.73≤F≤1.79. For example, the value of F may be 1.65, 1.67, 1.69, 1.71, 1.73, 1.75, 1.77, 1.79 or a range consisting of any two of these values. When the value of F is within the above range, the negative electrode material layer has an appropriate thickness and porosity, improving the energy density and fast-charging performance of the electrochemical device.

This application has no particular limitation on the method for regulating the compacted density F of the negative electrode material layer, as long as the purpose of this application can be achieved. For example, the compacted density F of the negative electrode material layer may be regulated by regulating the rolling pressure in the cold pressing process. Illustratively, when the rolling pressure in the cold pressing process is increased, the compacted density F of the negative electrode material layer increases; when the rolling pressure in the cold pressing process is decreased, the compacted density F of the negative electrode material layer decreases.

In one embodiment of this application, the negative electrode material layer has a thickness D₂ of 32 μm to 66 μm. For example, the thickness D₂ of the negative electrode material layer may be 32 μm, 40 μm, 45 μm, 50 μm, 55 μm, 60 μm, 66 μm or a range consisting of any two of these values. When the thickness D₂ of the negative electrode material layer is within the above range, the areal capacity of the negative electrode plate can be increased, and the energy density of the electrochemical device can be improved. In addition, the transport distance of ions and electrons in the negative electrode material layer can be shortened, and the sheet resistance of the negative electrode plate can be reduced, thereby improving the fast-charging performance of the electrochemical device. The thickness D₂ of the negative electrode material layer mentioned above refers to the thickness of the negative electrode material layer on a single side after cold pressing.

This application has no particular limitation on the method for regulating the thickness D₂ of the negative electrode material layer, as long as the purpose of this application can be achieved. For example, the thickness D₂ of the negative electrode material layer may be regulated by regulating the coating weight of the negative electrode material layer. On the basis of a certain compacted density of the negative electrode material layer, when the coating weight of the negative electrode material layer is increased, the thickness D₂ of the negative electrode material layer increases; when the coating weight of the negative electrode material layer is decreased, the thickness D₂ of the negative electrode material layer decreases.

In one embodiment of this application, the negative electrode plate has a sheet resistance R of 9.2 Ω·cm to 28.7 Ω·cm. For example, the sheet resistance R of the negative electrode plate may be 9.2 Ω·cm, 10 Ω·cm, 15 Ω·cm, 20 Ω·cm, 25 Ω·cm, 28.7 Ω·cm or a range consisting of any two of these values. When the sheet resistance R of the negative electrode plate is within the above range, the conductivity of the negative electrode plate can be improved, enhancing the cycling performance of the electrochemical device.

This application has no particular limitation on the method for regulating the sheet resistance R of the negative electrode plate, as long as the purpose of this application can be achieved. For example, the sheet resistance R of the negative electrode plate may be regulated by regulating the average particle diameter D₁ of the silicon-carbon particles, or the sheet resistance R of the negative electrode plate may be regulated by the mass ratio of the silicon-carbon particles to the carbon material. Illustratively, when D₁ is increased, the value of R increases, and when D₁ is decreased, the value of R decreases; when the mass ratio of the silicon-carbon particles to the carbon material is increased, the value of R increases, and when the mass ratio of the silicon-carbon particles to the carbon material is decreased, the value of R decreases.

In this application, the negative electrode plate includes a negative electrode current collector and a negative electrode material layer provided on at least one surface of the negative electrode current collector. The phrase “negative electrode material layer provided on at least one surface of the negative electrode current collector” mentioned above means that the negative electrode material layer may be provided on one surface of the negative electrode current collector in the thickness direction thereof, or may be provided on two surfaces of the negative electrode current collector in the thickness direction thereof. It should be noted that the “surface” here may be the entire area of the surface of the negative electrode current collector or a partial area of the surface of the negative electrode current collector, and this application has no particular limitation thereon, as long as the purpose of this application can be achieved.

This application has no particular limitation on the negative electrode current collector, as long as the purpose of this application can be achieved. For example, the negative electrode current collector may include copper foil, copper alloy foil, nickel foil, stainless steel foil, titanium foil, nickel foam, copper foam, lithium-copper composite current collector, carbon-copper composite current collector, nickel-copper composite current collector, or titanium-copper composite current collector. This application has no particular limitation on the thickness of the negative electrode current collector, as long as the purpose of this application can be achieved. For example, the thickness of the negative electrode current collector may be 4 μm to 15 μm.

In some embodiments of this application, the negative electrode material layer may further include a conductive agent and a binder. This application has no particular limitation on the types of the conductive agent and the binder, as long as the purpose of this application can be achieved. For example, the conductive agent may include but is not limited to at least one of conductive carbon black, carbon nanotubes (CNTs), carbon fibers, flake graphite, graphene, metal materials, or conductive polymers. The conductive carbon black mentioned above may include but is not limited to at least one of Super P, acetylene black, or Ketjen black. The carbon nanotubes mentioned above may include but are not limited to single-walled carbon nanotubes and/or multi-walled carbon nanotubes. The carbon fibers mentioned above may include but are not limited to vapor-grown carbon fibers (VGCF) and/or carbon nanofibers. The metal materials mentioned above may include but are not limited to metal powder and/or metal fibers, and specifically, the metal may include but is not limited to at least one of copper, nickel, aluminum, or silver. The conductive polymers mentioned above may include but are not limited to at least one of polyphenylene derivatives, polyaniline, polythiophene, polyacetylene, or polypyrrole. The binder may include but is not limited to at least one of polyacrylic acid, sodium polyacrylate, potassium polyacrylate, lithium polyacrylate, polyimide, carboxymethyl cellulose, sodium carboxymethyl cellulose, lithium carboxymethyl cellulose, polyimide, polyamide-imide, polyvinylidene fluoride, polyvinyl alcohol, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon. This application has no particular limitation on the mass ratio of the negative electrode material, the conductive agent, and the binder in the negative electrode material layer, and a person skilled in the art may select appropriate ratios according to actual needs, as long as the purpose of this application can be achieved.

In some embodiments of this application, the negative electrode material layer may further include a conductive agent, a binder, and a thickener. This application has no particular limitation on the types of the conductive agent, the binder, and the thickener, as long as the purpose of this application can be achieved. For example, the conductive agent and the binder may be at least one of the foregoing conductive agents and the foregoing binders. The thickener may include but is not limited to at least one of carboxymethyl cellulose, sodium carboxymethyl cellulose, or lithium carboxymethyl cellulose. This application has no particular limitation on the mass ratio of the negative electrode material, the conductive agent, the binder, and the thickener in the negative electrode material layer, and a person skilled in the art may select appropriate ratios according to actual needs, as long as the purpose of this application can be achieved.

Optionally, the negative electrode plate may further include a conductive layer, and the conductive layer is located between the negative electrode current collector and the negative electrode material layer. This application has no particular limitation on the composition of the conductive layer, and it may be a conductive layer commonly used in the art. For example, the conductive layer includes a conductive agent and a binder. This application has no particular limitation on the conductive agent and the binder in the conductive layer. For example, the conductive agent and the binder may be at least one of the foregoing conductive agents and the foregoing binders.

In one embodiment of this application, the electrolyte includes lithium difluorophosphate, and based on a mass of the electrolyte, a mass percentage of lithium difluorophosphate is G %, where 0.01≤G≤2, preferably 0.05≤G≤0.95. For example, G may be 0.01, 0.05, 0.1, 0.5, 0.95, 1, 1.5, 2 or a range consisting of any two of these values. When G is within the above range, it is beneficial to obtain a fluorine-containing SEI film, so as to promote uniform lithium deposition and reduce side reactions between the electrolyte and the negative electrode material, thereby improving the cycling performance of the electrochemical device and prolonging the cycle life of the electrochemical device.

In one embodiment of this application, the electrolyte includes fluoroethylene carbonate, and based on a mass of the electrolyte, a mass percentage of fluoroethylene carbonate is E %, where 7≤E≤20, preferably 10≤E≤15. For example, E may be 7, 10, 12, 15, 17, 20 or a range consisting of any two of these values. When E is within the above range, it is beneficial to obtain a fluorine-containing SEI film, so as to promote uniform lithium deposition and reduce side reactions between the electrolyte and the negative electrode material, thereby improving the cycling performance of the electrochemical device and prolonging the cycle life of the electrochemical device.

In one embodiment of this application, the electrolyte includes vinylene carbonate, and based on a mass of the electrolyte, a mass percentage of vinylene carbonate is H %, where 0.01≤H≤2, preferably 0.01≤H≤0.85. For example, H may be 0.01, 0.1, 0.5, 0.85, 1, 1.5, 2 or a range consisting of any two of these values. When H is within the above range, a relatively stable and dense SEI film can be generated on the surface of the negative electrode plate. This can effectively reduce side reactions between the negative electrode material and the electrolyte, thereby improving the stability of the negative electrode material and prolonging the cycle life of the electrochemical device.

In one embodiment of this application, the electrolyte includes fluoroethylene carbonate, and based on a mass of the electrolyte, a mass percentage of fluoroethylene carbonate is E %, where 1.6≤A/E≤2.9. For example, the value of A/E may be 1.6, 1.9, 2.2, 2.5, 2.7, 2.9 or a range consisting of any two of these values. When the value of A/E is within the above range, a relatively stable and dense SEI film can be formed on the surface of the negative electrode material, and the SEI film is mainly composed of inorganic salts (such as lithium carbonate and lithium oxide) and organic substances (such as polymers). This can effectively reduce side reactions between the negative electrode material and the electrolyte, protect the negative electrode material, and prolong the cycle life of the electrochemical device.

In this application, the electrolyte includes a lithium salt and a non-aqueous solvent. This application has no particular limitation on the lithium salt, as long as the purpose of this application can be achieved. For example, the lithium salt may include but is not limited to at least one of LiPF₆, LiBF₄, LiAsF₆, LiClO₄LiB(C₆H₅)₄, LiCH₃SO₃LiCF₃SO₃, LiN(SO₂CF₃)₂, LiC(SO₂CF₃)₃, Li₂SiF₆, lithium bis(oxalato)borate (LiBOB), or lithium difluoro(oxalato)borate. This application has no particular limitation on the mass percentage of the lithium salt in the electrolyte, as long as the purpose of this application can be achieved. For example, based on the mass of the electrolyte, the mass percentage of the lithium salt may be 8% to 20%.

This application has no particular limitation on the non-aqueous solvent, as long as the purpose of this application can be achieved. For example, the non-aqueous solvent may include but is not limited to at least one of carbonate compounds, carboxylate compounds, ether compounds, or other organic solvents. The carbonate compounds mentioned above may include but are not limited to at least one of chain carbonate compounds, cyclic carbonate compounds, or fluorinated carbonate compounds. The chain carbonate compounds mentioned above may include but are not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonate compounds mentioned above may include but are not limited to at least one of ethylene carbonate (EC), propylene carbonate (PC), butylene carbonate (BC), or vinyl ethylene carbonate (VEC). The fluorinated carbonate compounds mentioned above may include but are not limited to at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compounds mentioned above may include but are not limited to at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compounds mentioned above may include but are not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents mentioned above may include but are not limited to at least one of dimethyl sulfoxide, 1,2-dioxolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. This application has no particular limitation on the mass percentage of the non-aqueous solvent in the electrolyte, as long as the purpose of this application can be achieved. For example, based on the mass of the electrolyte, the mass percentage of the non-aqueous solvent may be 56% to 84%.

In one embodiment of this application, the electrolyte may include fluoroethylene carbonate, lithium difluorophosphate, vinylene carbonate, a lithium salt, and a non-aqueous solvent. The mass percentages of fluoroethylene carbonate, lithium difluorophosphate, vinylene carbonate, and the lithium salt are as described above, and the mass percentage of the non-aqueous solvent is 56% to 84%. The electrochemical device including the above electrolyte has good fast-charging performance and room-temperature storage performance, and can ameliorate lithium precipitation at the negative electrode.

In this application, the electrochemical device includes a positive electrode plate, and the positive electrode plate includes a positive electrode current collector and a positive electrode material layer provided on at least one surface of the positive electrode current collector. The phrase “positive electrode material layer provided on at least one surface of the positive electrode current collector” mentioned above means that the positive electrode material layer may be provided on one surface of the positive electrode current collector in the thickness direction thereof, or may be provided on two surfaces of the positive electrode current collector in the thickness direction thereof. It should be noted that the “surface” here may be the entire area of the surface of the positive electrode current collector or a partial area of the surface of the positive electrode current collector. This application has no particular limitation thereon, as long as the purpose of this application can be achieved.

This application has no particular limitation on the positive electrode current collector, as long as the purpose of this application can be achieved. For example, a metal foil or a composite current collector may be used. For example, the metal foil may include but is not limited to aluminum foil; the composite current collector may be obtained by forming a metal material (copper, copper alloy, nickel, nickel alloy, titanium, titanium alloy, silver, silver alloy, and the like.) on a polymer substrate.

In this application, the positive electrode material layer includes a positive electrode active material, and this application has no particular limitation on the positive electrode active material, as long as the purpose of this application can be achieved. For example, the positive electrode active material may include but is not limited to at least one of lithium nickel cobalt manganese oxide (such as NCM811, NCM622, NCM523, NCM111), lithium nickel cobalt aluminate, lithium iron phosphate, lithium-rich manganese-based materials, lithium cobalt oxide (LiCoO₂), lithium manganese oxide, lithium iron manganese phosphate, lithium titanate, lithium nickel manganese aluminate, lithium vanadium phosphate, lithium cobalt phosphate, lithium manganese phosphate, lithium iron silicate, lithium vanadium silicate, lithium cobalt silicate, lithium manganese silicate, or spinel lithium nickel manganese oxide.

In this application, the positive electrode material layer may further include a conductive agent and a binder. This application has no particular limitation on the types of the conductive agent and the binder, as long as the purpose of this application can be achieved. For example, the conductive agent and the binder may be at least one of the foregoing conductive agents and the foregoing binders. This application has no particular limitation on the mass ratio of the positive electrode active material, the conductive agent, and the binder in the positive electrode material layer, and a person skilled in the art may select appropriate ratios according to actual needs, as long as the purpose of this application can be achieved.

This application has no particular limitation on the thickness of the positive electrode current collector and the positive electrode material layer, as long as the purpose of this application can be achieved. For example, the thickness of the positive electrode current collector is 5 μm to 20 μm, and the thickness of the positive electrode material layer on a single side is 30 μm to 150 μm.

Optionally, the positive electrode plate may further include a conductive layer, and the conductive layer is located between the positive electrode current collector and the positive electrode material layer. The composition of the conductive layer is not particularly limited, and it may be a conductive layer commonly used in the art. The conductive layer includes a conductive agent and a binder. This application has no particular limitation on the conductive agent and the binder in the conductive layer. For example, the conductive agent and the binder may be at least one of the foregoing conductive agents and the foregoing binders.

In this application, the electrochemical device further includes a separator. This application has no particular limitation on the separator, as long as the purpose of this application can be achieved. For example, the material of the separator may include but is not limited to at least one of polyolefin (PO) such as polyethylene (PE) and polypropylene (PP), polyester (for example, polyethylene terephthalate (PET) film), cellulose, polyimide (PI), polyamide (PA), spandex, or aramid. The type of the separator may include at least one of a woven film, a non-woven film, a microporous film, a composite film, a calendered film, or a spun film.

In some embodiments of this application, the separator may include a substrate layer and a surface treatment layer. The substrate layer may be a non-woven fabric or a composite film having a porous structure, and the material of the substrate layer may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used.

Optionally, at least one surface of the substrate layer is provided with a surface treatment layer, and the surface treatment layer may be a polymer layer or an inorganic layer, or may be a layer formed by mixing a polymer and an inorganic substance. In some embodiments of this application, the inorganic layer includes inorganic particles and a binder. This application has no particular limitation on the inorganic particles. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application has no particular limitation on the binder. For example, the binder may be at least one of the foregoing binders. In some embodiments of this application, the polymer layer includes a polymer, and the material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene).

In this application, the thickness of the separator is not particularly limited, as long as the purpose of this application can be achieved. For example, the thickness of the separator may be 3 μm to 30 μm.

In this application, the electrochemical device further includes a casing for accommodating the positive electrode plate, the separator, the negative electrode plate, and the electrolyte, as well as other components known in the field of electrochemistry. This application does not limit the above other components. This application has no particular limitation on the casing, and it may be a casing known in the art, as long as the purpose of this application can be achieved. For example, the casing may be a hard casing or a soft casing. The material of the hard casing may be metal, and this application does not limit the type of the metal, and a metal hard casing known in the art may be used, as long as the purpose of this application can be achieved. The soft casing may be a metal plastic film, such as an aluminum plastic film and a steel plastic film.

This application has no particular limitation on the type of the electrochemical device, and the electrochemical device may include any device in which an electrochemical reaction occurs. In this application, the electrochemical device may include but is not limited to: a lithium metal electrochemical device, a lithium-ion electrochemical device (lithium-ion battery), a lithium polymer electrochemical device, or a lithium-ion polymer electrochemical device (lithium-ion polymer battery), and the like.

The preparation process of the electrochemical device is well known to a person skilled in the art, and this application has no particular limitation thereon. For example, the preparation process of the electrochemical device may include but is not limited to the following steps: stacking the positive electrode plate, the separator, and the negative electrode plate in order, and performing operations such as winding or folding as needed to obtain an electrode assembly with a wound structure, placing the electrode assembly into a casing, injecting the electrolyte into the casing, and sealing the casing to obtain the electrochemical device. Alternatively, the positive electrode plate, the separator, and the negative electrode plate are stacked in order, and then the four corners of the entire laminated structure are fixed with tape to obtain an electrode assembly with a laminated structure, the electrode assembly is placed into a casing, the electrolyte is injected into the casing, and sealing is performed to obtain the electrochemical device. In addition, overcurrent prevention elements, guide plates, and the like may be placed into the casing as needed, thereby preventing pressure rise and overcharge/overdischarge inside the electrochemical device.

In a fourth aspect, this application provides an electronic device. The electronic device includes the electrochemical device in any of the foregoing embodiments. The electronic device of this application has good performance in use.

This application has no particular limitation on the type of the electronic device, and any electronic device known in the prior art may be used. In some embodiments of this application, the electronic device may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini disc, a transceiver, an electronic organizer, a calculator, a memory card, a portable recorder, a radio, a backup power supply, a motor, an automobile, a motorcycle, a power-assisted bicycle, a bicycle, a lighting fixture, a toy, a game console, a clock, an electric tool, a flash lamp, a camera, a large household battery, and a lithium-ion capacitor, and the like.

### EXAMPLES

Hereinafter, examples and comparative examples were given to more specifically illustrate the embodiments of this application. Various tests and evaluations were performed according to the following methods. In addition, unless otherwise specified, “parts” and “%” were on a mass basis.

### Test Methods and Equipment:

### Test of the Values of A and B:

An argon ion monoatomic beam was used to etch the silicon-carbon particles in each example or comparative example, with an etching depth of 0 nm to 40 nm, and then the atomic percentage A of the silicon element in the first region from 0 nm to 40 nm on the surface of the sample was tested. The above silicon-carbon particles were continued to be etched, with an etching depth of 60 nm to 100 nm, and then the atomic percentage B of the silicon element in the second region from a depth of 60 nm from the surface of the sample to a depth of 100 nm from the surface of the sample was tested. The equipment used for the test was a PHI 5000 Versaprobe II X-ray photoelectron spectrometer, and the X-ray excitation source was Al target Ka ray.

### Test of the Average Particle Diameter of Silicon-Carbon Particles:

The negative electrode plate was subjected to plasma-based longitudinal cutting along the thickness direction, polished using argon ion polishing technology to obtain a flat cross-section, and then a scanning electron microscope (SEM, model OXFORD⋅EDS) was used to take SEM photos at a magnification of 50,000 times and observe the silicon-carbon particles, and then image analysis software was used to randomly select 30 silicon-carbon particles from the SEM photos and calculate the respective areas of these silicon-carbon particles, and then, assuming that the silicon-carbon particles were spherical, the respective particle diameters D (diameter) were calculated by the following formula: D=2×(S₁/π)^{1/2}, where S₁ was the area of the silicon-carbon particles; and the average of the particle diameters of the obtained 30 silicon-carbon particles was taken as the average particle diameter D₁ of the silicon-carbon particles.

### Test of the Compacted Density of the Negative Electrode Material Layer:

The lithium-ion battery was charged at 0.2C to 4.45 V and then discharged at 0.2C to 3.0 V, and the discharge capacity was recorded as C₁. Then, the lithium-ion battery was charged at 0.2C to a capacity cutoff of C₁/2, at which time the lithium-ion battery was in a half-charged state. The lithium-ion battery was disassembled to obtain the negative electrode plate in the half-charged state, the negative electrode plate was cleaned with dimethyl carbonate (DMC) and vacuum-dried, and then a negative electrode plate sample with an area of S cm² was cut out, the thickness of the negative electrode plate sample was measured as Y₁ cm and the mass was measured as M₁ g, and then the negative electrode material layer of the negative electrode plate sample was peeled off, the thickness of the negative electrode current collector was measured as Y₂ cm and the mass was measured as M₂ g, and the compacted density F=(M₁−M₂)/(S×(Y₁−Y₂)) of the negative electrode material layer was calculated, in units of g/cm³.

### Test of the Sheet Resistance of the Negative Electrode Plate:

The negative electrode plate was cleaned with dimethyl carbonate (DMC) and vacuum-dried to obtain a dried negative electrode plate. The negative electrode plate was cut into a test sample of 60 mm×80 mm, and a sheet resistance tester was used, with a test pressure of 0.4 T and a pressure holding time of 10 s, to test the sheet resistance R of the negative electrode plate.

### Test of the Powder Resistivity of Silicon-Carbon Particles:

In a dry room, a powder resistivity tester was used to test the powder resistivity of the silicon-carbon particles in each example and comparative example.

### Room-Temperature Storage Performance Test:

The lithium-ion battery was charged at a constant current of 0.2C to 4.45 V at 25° C., then charged at a constant voltage of 4.45 V to 0.05C, left standing for 5 minutes, and then discharged at a constant current of 0.2C to 3.0 V, and the discharge capacity at this time was recorded as C₀. Then the lithium-ion battery was charged at a constant current of 0.2C to 4.45 V, then charged at a constant voltage of 4.45 V to 0.05C, and then the lithium-ion battery was placed in a constant temperature chamber at 25° C. for 120 days, taken out, left standing for 30 minutes, and discharged at a constant current of 0.2C to 3.0 V, and the discharge capacity at this time was recorded as C₂. The discharge capacity retention rate (%) of the lithium-ion battery after storage at 25° C. for 120 days was C₂/C₀ multiplied by 100%.

Ten lithium-ion batteries were tested in each group, and a lithium-ion battery with a discharge capacity retention rate greater than or equal to 80% after storage at 25° C. for 120 days was regarded as passing the test, and the room-temperature storage test pass rate (%) is equal to the number of batteries with a discharge capacity retention rate greater than or equal to 80% after storage at 25° C. for 120 days divided by 10 multiplied by 100%.

A higher room-temperature storage test pass rate indicates better room-temperature storage performance of the lithium-ion battery.

### Lithium Precipitation Test:

The lithium-ion battery to be tested was left standing for 5 minutes at a test temperature of 0° C., charged at a constant current of 0.2C to 4.45 V, then charged at a constant voltage of 4.45 V to 0.05C, at which time the lithium-ion battery reached a fully charged state; left standing for 5 minutes, and then discharged at a constant current of 0.2C to 3.0 V, and left standing for 5 minutes. The above charge-discharge process was repeated 10 times, the lithium-ion battery was fully charged, disassembled in a dry room, and the state of the negative electrode plate was recorded by taking photos.

Determination of lithium precipitation degree: The determination was based on the condition of the disassembled negative electrode plate at full charge. When the area showing gray on the negative electrode plate was less than 2%, no lithium precipitation is determined; when the gray area on the negative electrode plate was greater than or equal to 2% and less than 20%, slight lithium precipitation is determined; when the gray area on the negative electrode plate was greater than or equal to 20% and less than 30%, lithium precipitation is determined; when the gray area on the negative electrode plate was greater than or equal to 30%, severe lithium precipitation is determined.

### Rate Capability Charging Capacity Retention Rate Test:

At 25° C., the lithium-ion battery was charged at 0.2C to 4.45 V, and the charging capacity at this time was recorded as C₃. After being left standing for 5 minutes, the lithium-ion battery was then discharged at 0.2C to 3.0 V, and charged at 2C to 4.45 V, and the charging capacity at this time was recorded as C₄. Then, the lithium-ion battery was left standing for 5 minutes, and then discharged at 0.2C to 3.0 V.

Charging capacity retention rate at 2C (%)=C₄/C₃×100%.

The ratio of the charging capacity at 2C to the charging capacity at 0.2C of the lithium-ion battery was used to characterize the fast-charging performance of the lithium-ion battery. A higher charging capacity retention rate at 2C indicates better fast-charging performance of the lithium-ion battery.

### Example 1-1

### <Preparation of Negative Electrode Material>

(1) A porous carbon matrix was provided, the porous carbon matrix was subjected to a first heat-preserving treatment under a nitrogen atmosphere, and then a silane-containing gas was introduced to obtain a first intermediate. The average particle diameter of the porous carbon matrix was 7.8 μm; the temperature T₁ of the first heat-preserving treatment was 420° C., the duration t₁ of the first heat-preserving treatment was 2 h; the duration t₂ of introducing the silane-containing gas was 800 min; the flow rate V₁ of the silane-containing gas was 1 L/min; the silane-containing gas was methylsilane.
(2) The first intermediate was subjected to a second heat-preserving treatment under a nitrogen atmosphere, and then a first compound was introduced to obtain silicon-carbon particles. The temperature T₂ of the second heat-preserving treatment was 540° C., the duration t₃ of the second heat-preserving treatment was 1 h; the duration t₄ of introducing the first compound was 240 min; the flow rate V₂ of the first compound was 6 L/min; the first compound was acetylene.
(3) The silicon-carbon particles and the carbon material artificial graphite were uniformly mixed in a mass ratio of 12:88 to obtain the negative electrode material.

### <Preparation of Negative Electrode Plate>

The negative electrode material prepared above, the binder styrene-butadiene rubber (SBR), and the thickener carboxymethyl cellulose (CMC) were mixed in a mass ratio of 98:1.6:0.4, dissolved in the solvent deionized water, and uniformly mixed to prepare a negative electrode slurry with a solid content of 45 wt %. The negative electrode slurry was uniformly applied on one surface of a negative electrode current collector copper foil with a thickness of 6 μm, dried at 85° C. for 4 h to obtain a negative electrode plate coated with a negative electrode material layer on a single side, and the coating weight of the negative electrode material layer was 99.73 mg/1540.25 mm². Then the above steps were repeated on the other surface of the copper foil to obtain a negative electrode plate coated with negative electrode material layers on both sides. After cold pressing, cutting, and slitting, drying was performed under vacuum at 120° C. for 12 hours to obtain a negative electrode plate with a specification of 76.6 mm×875 mm for use. The thickness of the negative electrode material layer on a single side after cold pressing was 37 μm, and the compacted density of the negative electrode material layer was 1.75 g/cm³.

### <Preparation of Positive Electrode Plate>

The positive electrode active material lithium nickel cobalt manganese oxide (NCM811), the conductive agent acetylene black, and the binder polyvinylidene fluoride (PVDF) were mixed in a mass ratio of 96.3:2.2:1.5, added to the solvent N-methylpyrrolidone, and stirred to uniformity to obtain a positive electrode slurry with a solid content of 75 wt %. The positive electrode slurry was uniformly applied on one surface of a positive electrode current collector aluminum foil with a thickness of 13 μm, dried at 85° C. to obtain a positive electrode plate coated with a positive electrode material layer on a single side, and the coating weight of the positive electrode material layer was 231.29 mg/1540.25 mm². Then the above steps were repeated on the other surface of the aluminum foil to obtain a positive electrode plate coated with positive electrode material layers on both sides. After cold pressing, cutting, and slitting, drying was performed under vacuum at 85° C. for 4 hours to obtain a positive electrode plate with a specification of 74 mm×867 mm for use. The thickness of the positive electrode material layer on a single side after cold pressing was 35.5 μm, and the compacted density of the positive electrode material layer was 4.23 g/cm³.

### <Preparation of Electrolyte>

In an argon atmosphere glove box with a water content less than 10 ppm, ethylene carbonate (EC) and dimethyl carbonate (DMC) were uniformly mixed in a volume ratio of 1:1 to obtain a base solvent, and fluoroethylene carbonate, lithium difluorophosphate, vinylene carbonate, and the lithium salt LiPF₆ were added to the base solvent and stirred to uniformity to obtain the electrolyte. Based on the total mass of the electrolyte, the mass percentage E of fluoroethylene carbonate was 12.5%, the mass percentage G of lithium difluorophosphate was 0.5%, the mass percentage H of vinylene carbonate was 0.4%, the mass percentage of LiPF₆ was 12.5%, and the mass percentage of the base solvent was 74.1%.

### <Separator>

A polypropylene (PP) separator with a thickness of 4.5 μm was used.

### <Preparation of Lithium-Ion Battery>

The positive electrode plate with welded tabs, the separator, and the negative electrode plate with welded tabs were sequentially stacked, with the separator located between the positive electrode plate and the negative electrode plate to play a role of isolation. The assembly was then wound to obtain an electrode assembly. The electrode assembly was placed into an aluminum plastic film, dried in a vacuum oven at 80° C. for 12 hours to remove moisture, the prepared electrolyte was injected, and after vacuum encapsulation, standing, formation, degassing, and edge cutting processes, a lithium-ion battery was obtained.

### Examples 1-2 to 1-9

Except for regulating the preparation parameters in <Preparation of negative electrode material> with reference to Table 1 so that the values of A and B were as shown in Table 1, the rest was the same as in Example 1-1.

### Example 1-10

Except that ethylsilane was used as the silane-containing gas in <Preparation of negative electrode material> and the relevant preparation parameters were regulated according to Table 1, the rest was the same as in Example 1-1.

### Example 1-11

Except that propylene was used as the first compound in <Preparation of negative electrode material> and the relevant preparation parameters were regulated according to Table 1, the rest was the same as in Example 1-1.

### Examples 1-12 to 1-13

Except for regulating the preparation parameters in <Preparation of negative electrode material> with reference to Table 1 so that the powder resistivity ρ of the silicon-carbon particles was as shown in Table 1, the rest was the same as in Example 1-1.

### Examples 1-14 to 1-17

Except for regulating the average particle diameter D₁ of the silicon-carbon particles in <Preparation of negative electrode material> according to Table 1, the rest was the same as in Example 1-1.

### Examples 1-18 to 1-19

Except for regulating the mass ratio of the silicon-carbon particles to the carbon material in <Preparation of negative electrode material> so that the sheet resistance R of the negative electrode plate was as shown in Table 2, the rest was the same as in Example 1-1.

### Examples 1-20 to 1-24

Except for regulating the coating weight of the negative electrode material layer in <Preparation of negative electrode material> according to Table 2 so that the thickness D₂ of the negative electrode material layer was as shown in Table 1, the rest was the same as in Example 1-1.

### Examples 2-1 to 2-11

Except for regulating the preparation parameters in <Preparation of electrolyte> according to Table 3, the rest was the same as in Example 1-1. When the mass percentage of at least one of lithium difluorophosphate, fluoroethylene carbonate, or vinylene carbonate changed, the mass percentage of the base solvent changed accordingly, while the mass percentage of the lithium salt and the volume ratio of each component in the base solvent remained unchanged.

### Comparative Examples 1 to 6

Except for regulating the preparation parameters in <Preparation of negative electrode material> with reference to Table 1 so that the values of A and B were as shown in Table 1, the rest was the same as in Example 1-1.

The preparation parameters and performance test results of each example and comparative example were shown in Tables 1, 2, and 3.

TABLE 1

| | T₁ | t₂ | V₁ | T₂ | t₄ | V₂ | A | B | | D₁ | ρ |
|---|---|---|---|---|---|---|---|---|---|---|---|
| | (° C.) | (min) | (L/min) | (° C.) | (min) | (L/min) | (%) | (%) | B/A | (μm) | (Ω · cm) |
| Example 1-1 | 420 | 800 | 1 | 540 | 240 | 6 | 25.8 | 25.4 | 0.98 | 7.8 | 0.96 |
| Example 1-2 | 380 | 800 | 1 | 540 | 240 | 6 | 19.4 | 30.1 | 1.55 | 7.7 | 0.67 |
| Example 1-3 | 400 | 800 | 1 | 540 | 240 | 6 | 23.2 | 27.5 | 1.19 | 7.8 | 0.73 |
| Example 1-4 | 440 | 800 | 1 | 540 | 240 | 6 | 28.3 | 24.3 | 0.86 | 7.9 | 1.38 |
| Example 1-5 | 460 | 800 | 1 | 540 | 240 | 6 | 35.2 | 23.8 | 0.68 | 7.8 | 2.07 |
| Example 1-6 | 420 | 400 | 2 | 540 | 240 | 6 | 36.7 | 24.2 | 0.66 | 7.7 | 0.71 |
| Example 1-7 | 420 | 540 | 1.5 | 540 | 240 | 6 | 29.2 | 23.9 | 0.82 | 7.8 | 0.72 |
| Example 1-8 | 420 | 1000 | 0.8 | 540 | 240 | 6 | 24.3 | 31.3 | 1.29 | 7.9 | 0.99 |
| Example 1-9 | 420 | 1600 | 0.5 | 540 | 240 | 6 | 20.1 | 31.8 | 1.58 | 7.9 | 1.05 |
| Example 1-10 | 410 | 400 | 1 | 540 | 240 | 6 | 27.1 | 28.6 | 1.06 | 7.9 | 1.02 |
| Example 1-11 | 420 | 800 | 1 | 600 | 180 | 4 | 25.2 | 25.5 | 1.01 | 7.7 | 0.38 |
| Example 1-12 | 420 | 800 | 1 | 570 | 240 | 3 | 24.8 | 25.1 | 1.01 | 7.9 | 0.25 |
| Example 1-13 | 420 | 800 | 1 | 480 | 240 | 10 | 26.3 | 28.2 | 1.07 | 7.8 | 8.7 |
| Example 1-14 | 420 | 800 | 1 | 540 | 240 | 6 | 25.5 | 25.6 | 1.00 | 5 | 0.62 |
| Example 1-15 | 420 | 800 | 1 | 540 | 240 | 6 | 25.7 | 25.9 | 1.01 | 5.5 | 0.85 |
| Example 1-16 | 420 | 800 | 1 | 540 | 240 | 6 | 26.1 | 25.2 | 0.97 | 8.7 | 1.24 |
| Example 1-17 | 420 | 800 | 1 | 540 | 240 | 6 | 26.6 | 24.8 | 0.93 | 9.5 | 1.35 |
| Example 1-18 | 420 | 800 | 1 | 540 | 240 | 6 | 25.8 | 25.4 | 0.98 | 7.8 | 0.96 |
| Example 1-19 | 420 | 800 | 1 | 540 | 240 | 6 | 25.8 | 25.4 | 0.98 | 7.8 | 0.96 |
| Example 1-20 | 420 | 800 | 1 | 540 | 240 | 6 | 25.8 | 25.4 | 0.98 | 7.8 | 0.96 |
| Example 1-21 | 420 | 800 | 1 | 540 | 240 | 6 | 25.8 | 25.4 | 0.98 | 7.8 | 0.96 |
| Example 1-22 | 420 | 800 | 1 | 540 | 240 | 6 | 25.8 | 25.4 | 0.98 | 7.8 | 0.96 |
| Example 1-23 | 420 | 800 | 1 | 540 | 240 | 6 | 25.8 | 25.4 | 0.98 | 7.8 | 0.96 |
| Example 1-24 | 420 | 800 | 1 | 540 | 240 | 6 | 25.8 | 25.4 | 0.98 | 7.8 | 0.96 |
| Comparative | 420 | 800 | 1 | 540 | 480 | 6 | 18.3 | 29.8 | 1.63 | 7.9 | 0.86 |
| Example 1 | | | | | | | | | | | |
| Comparative | 420 | 800 | 1 | 540 | 60 | 6 | 37.5 | 23.9 | 0.64 | 7.7 | 3.49 |
| Example 2 | | | | | | | | | | | |
| Comparative | 500 | 800 | 1 | 540 | 240 | 6 | 34.5 | 19.1 | 0.55 | 7.8 | 1.23 |
| Example 3 | | | | | | | | | | | |
| Comparative | 360 | 800 | 1 | 540 | 240 | 6 | 25.1 | 32.5 | 1.29 | 7.8 | 0.65 |
| Example 4 | | | | | | | | | | | |
| Comparative | 420 | 270 | 3 | 540 | 240 | 6 | 38.9 | 10.5 | 0.27 | 7.9 | 10.88 |
| Example 5 | | | | | | | | | | | |
| Comparative | 420 | 2700 | 0.3 | 540 | 240 | 6 | 15.2 | 34.7 | 2.28 | 7.7 | 0.47 |
| Example 6 | | | | | | | | | | | |

TABLE 2

| | Mass ratio | | | | | | | |
|---|---|---|---|---|---|---|---|---|
| | of silicon- | | | | | Charging | | |
| | carbon | | | | | capacity | | Room- |
| | particles to | | | | | retention | Lithium | temperature |
| | carbon | R | F | D₂ | | rate at | precipitation | storage test |
| | material | (Ω · cm) | (g/cm³) | (μm) | A/E | 2 C (%) | test | pass rate (%) |
| Example 1-1 | 12:88 | 18.3 | 1.75 | 37 | 2.1 | 81.7 | No lithium | 100 |
| | | | | | | | precipitation | |
| Example 1-2 | 12:88 | 14.2 | 1.75 | 37 | 1.6 | 80.6 | Slight lithium | 100 |
| | | | | | | | precipitation | |
| Example 1-3 | 12:88 | 17.2 | 1.75 | 36 | 1.9 | 81.2 | No lithium | 100 |
| | | | | | | | precipitation | |
| Example 1-4 | 12:88 | 22.5 | 1.75 | 37 | 2.3 | 81.1 | No lithium | 100 |
| | | | | | | | precipitation | |
| Example 1-5 | 12:88 | 24.8 | 1.75 | 37 | 2.8 | 79.4 | No lithium | 100 |
| | | | | | | | precipitation | |
| Example 1-6 | 12:88 | 15.5 | 1.75 | 37 | 2.9 | 79.8 | No lithium | 80 |
| | | | | | | | precipitation | |
| Example 1-7 | 12:88 | 15.6 | 1.75 | 36 | 2.3 | 80.5 | No lithium | 100 |
| | | | | | | | precipitation | |
| Example 1-8 | 12:88 | 20.6 | 1.75 | 37 | 1.9 | 81.0 | No lithium | 100 |
| | | | | | | | precipitation | |
| Example 1-9 | 12:88 | 21.9 | 1.75 | 37 | 1.6 | 80.4 | Slight lithium | 90 |
| | | | | | | | precipitation | |
| Example 1-10 | 12:88 | 20.9 | 1.75 | 37 | 2.2 | 80.3 | No lithium | 100 |
| | | | | | | | precipitation | |
| Example 1-11 | 12:88 | 11.9 | 1.75 | 36 | 2.0 | 80.5 | No lithium | 100 |
| | | | | | | | precipitation | |
| Example 1-12 | 12:88 | 10.2 | 1.75 | 36 | 2.0 | 81.9 | No lithium | 100 |
| | | | | | | | precipitation | |
| Example 1-13 | 12:88 | 25.7 | 1.75 | 38 | 2.1 | 81.2 | No lithium | 100 |
| | | | | | | | precipitation | |
| Example 1-14 | 12:88 | 13.7 | 1.75 | 32 | 2.0 | 80.2 | No lithium | 100 |
| | | | | | | | precipitation | |
| Example 1-15 | 12:88 | 17.9 | 1.75 | 36 | 2.1 | 81.4 | No lithium | 100 |
| | | | | | | | precipitation | |
| Example 1-16 | 12:88 | 22.3 | 1.75 | 41 | 2.1 | 82.5 | No lithium | 100 |
| | | | | | | | precipitation | |
| Example 1-17 | 12:88 | 22.4 | 1.75 | 43 | 2.1 | 80.7 | Slight lithium | 80 |
| | | | | | | | precipitation | |
| Example 1-18 | 10:90 | 9.2 | 1.75 | 32 | 2.1 | 83.7 | No lithium | 100 |
| | | | | | | | precipitation | |
| Example 1-19 | 15:85 | 28.7 | 1.75 | 41 | 2.1 | 78.6 | No lithium | 100 |
| | | | | | | | precipitation | |
| Example 1-20 | 12:88 | 22.7 | 1.6 | 75 | 2.1 | 79.2 | No lithium | 90 |
| | | | | | | | precipitation | |
| Example 1-21 | 12:88 | 21.6 | 1.65 | 66 | 2.1 | 80.1 | No lithium | 100 |
| | | | | | | | precipitation | |
| Example 1-22 | 12:88 | 18.9 | 1.73 | 53 | 2.1 | 82.5 | No lithium | 100 |
| | | | | | | | precipitation | |
| Example 1-23 | 12:88 | 16.7 | 1.79 | 32 | 2.1 | 81.2 | No lithium | 100 |
| | | | | | | | precipitation | |
| Example 1-24 | 12:88 | 15.4 | 1.85 | 25 | 2.1 | 76.3 | Slight lithium | 80 |
| | | | | | | | precipitation | |
| Comparative | 12:88 | 18.2 | 1.75 | 38 | 1.5 | 80.3 | Severe lithium | 100 |
| Example 1 | | | | | | | precipitation | |
| Comparative | 12:88 | 25.2 | 1.75 | 36 | 3.0 | 76.9 | Severe lithium | 30 |
| Example 2 | | | | | | | precipitation | |
| Comparative | 12:88 | 22.5 | 1.75 | 37 | 2.8 | 72.7 | Severe lithium | 60 |
| Example 3 | | | | | | | precipitation | |
| Comparative | 12:88 | 14.6 | 1.75 | 37 | 2.0 | 74.1 | Slight lithium | 40 |
| Example 4 | | | | | | | precipitation | |
| Comparative | 12:88 | 35.6 | 1.75 | 36 | 3.1 | 69.5 | Severe lithium | 0 |
| Example 5 | | | | | | | precipitation | |
| Comparative | 12:88 | 12.8 | 1.75 | 37 | 1.2 | 70.8 | Severe lithium | 10 |
| Example 6 | | | | | | | precipitation | |

It can be seen from Examples 1-1 to 1-24 and Comparative Examples 1 to 6 that when the values of A and B and the preparation parameters of the negative electrode material were within the scope of this application, the lithium-ion battery obtained by applying the negative electrode material of this application had good fast-charging performance and room-temperature storage performance, and lithium precipitation at the negative electrode was ameliorated.

It can be seen from Examples 1-1 to 1-9 that when the value of B/A was within the scope of this application, the obtained lithium-ion battery had good fast-charging performance and room-temperature storage performance, and lithium precipitation at the negative electrode was ameliorated.

It can be seen from Example 1-1, Example 1-12, and Example 1-13 that when the value of ρ was within the scope of this application, the obtained lithium-ion battery had good room-temperature storage performance, and lithium precipitation at the negative electrode was ameliorated.

It can be seen from Example 1-1 and Examples 1-14 to 1-17 that when the value of D₁ was within the scope of this application, lithium precipitation at the negative electrode of the obtained lithium-ion battery was ameliorated, while having good fast-charging performance and room-temperature storage performance.

It can be seen from Example 1-1, Example 1-18, and Example 1-19 that when the value of R was within the scope of this application, the fast-charging performance of the obtained lithium-ion battery was improved, while having good room-temperature storage performance, and lithium precipitation at the negative electrode was ameliorated.

It can be seen from Example 1-1, Example 1-20, and Example 1-24 that when the value of F was within the scope of this application, the fast-charging performance of the obtained lithium-ion battery was improved, while having good room-temperature storage performance, and lithium precipitation at the negative electrode was ameliorated.

It can be seen from Example 1-1, Example 1-20, and Example 1-24 that when the value of D₂ was within the scope of this application, the fast-charging performance of the obtained lithium-ion battery was improved, while having good room-temperature storage performance, and lithium precipitation at the negative electrode was ameliorated.

TABLE 3

| | | | | | | Charging | | |
|---|---|---|---|---|---|---|---|---|
| | | | | | | capacity | | Room- |
| | | | | | | retention | Lithium | temperature |
| | G | E | H | A | | rate at | precipitation | storage test |
| | (%) | (%) | (%) | (%) | A/E | 2 C (%) | test | pass rate (%) |
| Example 1-1 | 0.5 | 12.5 | 0.4 | 25.8 | 2.1 | 81.7% | No lithium | 100 |
| | | | | | | | precipitation | |
| Example 2-1 | 0.01 | 12.5 | 0.4 | 25.8 | 2.1 | 80.2% | No lithium | 90 |
| | | | | | | | precipitation | |
| Example 2-2 | 0.05 | 12.5 | 0.4 | 25.8 | 2.1 | 80.7% | No lithium | 100 |
| | | | | | | | precipitation | |
| Example 2-3 | 0.95 | 12.5 | 0.4 | 25.8 | 2.1 | 81.4% | No lithium | 100 |
| | | | | | | | precipitation | |
| Example 2-4 | 2 | 12.5 | 0.4 | 25.8 | 2.1 | 79.2% | Slight lithium | 100 |
| | | | | | | | precipitation | |
| Example 2-5 | 0.5 | 7 | 0.4 | 25.8 | 3.7 | 78.8% | Slight lithium | 80 |
| | | | | | | | precipitation | |
| Example 2-6 | 0.5 | 10 | 0.4 | 25.8 | 2.6 | 81.2% | No lithium | 100 |
| | | | | | | | precipitation | |
| Example 2-7 | 0.5 | 15 | 0.4 | 25.8 | 1.7 | 80.9% | No lithium | 100 |
| | | | | | | | precipitation | |
| Example 2-8 | 0.5 | 20 | 0.4 | 25.8 | 1.3 | 78.5% | Slight lithium | 100 |
| | | | | | | | precipitation | |
| Example 2-9 | 0.5 | 12.5 | 0.01 | 25.8 | 2.1 | 81.0% | No lithium | 100 |
| | | | | | | | precipitation | |
| Example 2-10 | 0.5 | 12.5 | 0.85 | 25.8 | 2.1 | 81.6% | No lithium | 100 |
| | | | | | | | precipitation | |
| Example 2-11 | 0.5 | 12.5 | 2 | 25.8 | 2.1 | 80.7% | Slight lithium | 100 |
| | | | | | | | precipitation | |

It can be seen from Example 1-1 and Examples 2-1 to 2-4 that when the mass percentage G of lithium difluorophosphate was within the scope of this application, the fast-charging performance of the lithium-ion battery was improved, while having good room-temperature storage performance, and lithium precipitation at the negative electrode was ameliorated.

It can be seen from Example 1-1 and Examples 2-5 to 2-8 that when the mass percentage E of fluoroethylene carbonate was within the scope of this application, the fast-charging performance and room-temperature storage performance of the obtained lithium-ion battery were improved, and lithium precipitation at the negative electrode was ameliorated.

It can be seen from Example 1-1 and Examples 2-5 to 2-8 that when the value of A/E was within the scope of this application, the fast-charging performance and room-temperature storage performance of the obtained lithium-ion battery were improved, and lithium precipitation at the negative electrode was ameliorated.

It can be seen from Example 1-1 and Examples 2-9 to 2-11 that when the mass percentage H of vinylene carbonate was within the scope of this application, the fast-charging performance of the obtained lithium-ion battery was improved, while having good room-temperature storage performance, and lithium precipitation at the negative electrode was ameliorated.

It should be noted that in this specification, relational terms such as first and second are merely used to distinguish one entity or operation from another entity or operation, and do not necessarily require or imply any such actual relationship or order between these entities or operations. Moreover, the terms “comprise”, “include”, or any other variants thereof are intended to cover non-exclusive inclusion, so that a process, method, or article that includes a series of elements not only includes those elements, but also includes other elements not explicitly listed, or also includes elements inherent to such process, method, or article.

The embodiments in this specification are all described in a related manner, and the same or similar parts between the embodiments may refer to each other, with each embodiment focusing on the differences from other embodiments.

The above are merely preferred embodiments of this application and are not intended to limit this application. Any modifications, equivalent substitutions, improvements, and the like, made within the spirit and principles of this application shall be included within the protection scope of this application.

What is claimed is:

1. A negative electrode material, wherein the negative electrode material comprises silicon-carbon particles, and the silicon-carbon particles include a first region and a second region, the first region is a region extending from the surface of the silicon-carbon particles to a depth of 40 nm from the surface of the silicon-carbon particles; the second region is a region extending from a depth of 60 nm from the surface of the silicon-carbon particles to a depth of 100 nm from the surface of the silicon-carbon particles;
the silicon-carbon particles contain a silicon element and a carbon element;
based on a total number of atoms of the silicon element and the carbon element in the first region, an atomic percentage of the silicon element in the first region is A %, wherein 19.4≤A≤36.7; and
based on the total number of atoms of the silicon element and the carbon element in the second region, an atomic percentage of the silicon element in the second region is B %, wherein 23.8≤B≤31.8.

2. The negative electrode material according to claim 1, wherein 0.66≤B/A≤1.58.

3. The negative electrode material according to claim 2, wherein 0.82≤B/A≤1.29.

4. The negative electrode material according to claim 1, wherein the silicon-carbon particles have an average particle diameter D₁, D₁ is in the range of 5.5 μm to 8.7 μm.

5. The negative electrode material according to claim 1, wherein the silicon-carbon particles have a powder resistivity ρ, ρ is in the range of 0.25 Ω·cm to 8.7 Ω·cm.

6. A method for preparing the negative electrode material according to claim 1, wherein the preparation method of the silicon-carbon particles comprises following steps:
(1) providing a porous carbon matrix, subjecting the porous carbon matrix to a first heat-preserving treatment under inert atmosphere, and then introducing a silane-containing gas to obtain a first intermediate; wherein the temperature T₁ of the first heat-preserving treatment is in the range of 380° C. to 460° C., the duration t₁ of the first heat-preserving treatment is in the range of 1 h to 3 h; the duration t₂ of introducing the silane-containing gas is in the range of 400 min to 1600 min; the flow rate V₁ of the silane-containing gas is in the range of 0.5 L/min to 2 L/min; the silane-containing gas comprises at least one selected from the group consisting of methylsilane, ethylsilane, propylsilane, phenylsilane, and tolylsilane; and
(2) subjecting the first intermediate to a second heat-preserving treatment under inert atmosphere, and then introducing a first compound to obtain the silicon-carbon particles; wherein the temperature T₂ of the second heat-preserving treatment is in the range of 480° C. to 600° C., the duration t₃ of the second heat-preserving treatment is in the range of 0.5 h to 2 h; the duration t₄ of introducing the first compound is in the range of 120 min to 420 min; the flow rate V₂ of the first compound is in the range of 3 L/min to 10 L/min; the first compound comprises at least one selected from the group consisting of acetylene, propylene, and toluene.

7. An electrochemical device, wherein the electrochemical device comprises a negative electrode plate and an electrolyte, the negative electrode plate comprises a negative electrode current collector and a negative electrode material layer provided on at least one surface of the negative electrode current collector, and the negative electrode material layer comprises a negative electrode material, wherein the negative electrode material comprises silicon-carbon particles, and the silicon-carbon particles include a first region and a second region, the first region is a region extending from the surface of the silicon-carbon particles to a depth of 40 nm from the surface of the silicon-carbon particles; the second region is a region extending from a depth of 60 nm from the surface of the silicon-carbon particles to a depth of 100 nm from the surface of the silicon-carbon particles;
the silicon-carbon particles contains a silicon element and a carbon element;
based on a total number of atoms of the silicon element and the carbon element in the first region, an atomic percentage of the silicon element in the first region is A %, wherein 19.4≤A≤36.7; and
based on the total number of atoms of the silicon element and the carbon element in the second region, an atomic percentage of the silicon element in the second region is B %, wherein 23.8≤B≤31.8.

8. The electrochemical device according to claim 7, wherein 0.66≤B/A≤1.58.

9. The electrochemical device according to claim 7, wherein 0.82≤B/A≤1.29.

10. The electrochemical device according to claim 7, wherein the silicon-carbon particles have an average particle diameter D₁, D₁ is in the range of 5.5 μm to 8.7 μm.

11. The electrochemical device according to claim 7, wherein the silicon-carbon particles have a powder resistivity ρ, ρ is in the range of 0.25 Ω·cm to 8.7 Ω·cm.

12. The electrochemical device according to claim 7, wherein the negative electrode plate satisfies at least one of the following conditions:
(1) the negative electrode material layer has a compacted density F g/cm³, wherein 1.65≤F≤1.79;
(2) the negative electrode material layer has a thickness D₂ of 32 μm to 66 μm; or
(3) the negative electrode plate has a sheet resistance R of 9.2 Ω·cm to 28.7 Ω·cm.

13. The electrochemical device according to claim 7, wherein the electrolyte satisfies at least one of the following conditions:
(1) the electrolyte comprises lithium difluorophosphate, and based on a mass of the electrolyte, a mass percentage of lithium difluorophosphate is G %, wherein 0.01≤G≤2;
(2) the electrolyte comprises fluoroethylene carbonate, and based on a mass of the electrolyte, a mass percentage of fluoroethylene carbonate is E %, wherein 7≤E≤20; or
(3) the electrolyte comprises vinylene carbonate, and based on a mass of the electrolyte, a mass percentage of vinylene carbonate is H %, wherein 0.01≤H≤2.

14. The electrochemical device according to claim 13, wherein the electrolyte satisfies at least one of the following conditions:
$$0.05 \leq G \leq 0.95 ; \qquad ( 1 )$$
$$10 \leq E \leq 15 ; or \qquad ( 2 )$$
$$0.01 \leq H \leq 0.85 . \qquad ( 3 )$$

15. The electrochemical device according to claim 7, wherein the electrolyte comprises fluoroethylene carbonate, and based on a mass of the electrolyte, a mass percentage of fluoroethylene carbonate is E %, wherein 1.6≤A/E≤2.9.

16. An electronic device, wherein the electronic device comprises an electrochemical device, wherein the electrochemical device comprises a negative electrode plate and an electrolyte, the negative electrode plate comprises a negative electrode current collector and a negative electrode material layer provided on at least one surface of the negative electrode current collector, and the negative electrode material layer comprises a negative electrode material, wherein the negative electrode material comprises silicon-carbon particles, and the silicon-carbon particles include a first region and a second region, the first region is a region extending from the surface of the silicon-carbon particles to a depth of 40 nm from the surface of the silicon-carbon particles; the second region is a region extending from a depth of 60 nm from the surface of the silicon-carbon particles to a depth of 100 nm from the surface of the silicon-carbon particles;
the silicon-carbon particles contains a silicon element and a carbon element;
based on a total number of atoms of the silicon element and the carbon element in the first region, an atomic percentage of the silicon element in the first region is A %, wherein 19.4≤A≤36.7; and
based on the total number of atoms of the silicon element and the carbon element in the second region, an atomic percentage of the silicon element in the second region is B %, wherein 23.8≤B≤31.8.

17. The electronic device according to claim 16, wherein 0.66≤B/A≤1.58.

18. The electronic device according to claim 16, wherein the negative electrode plate satisfies at least one of the following conditions:
(1) the negative electrode material layer has a compacted density F g/cm³, wherein 1.65≤F≤1.79;
(2) the negative electrode material layer has a thickness D₂ of 32 μm to 66 μm; or
(3) the negative electrode plate has a sheet resistance R of 9.2 Ω·cm to 28.7 Ω·cm.

19. The electronic device according to claim 16, wherein the electrolyte satisfies at least one of the following conditions:
(1) the electrolyte comprises lithium difluorophosphate, and based on a mass of the electrolyte, a mass percentage of lithium difluorophosphate is G %, wherein 0.01≤G≤2;
(2) the electrolyte comprises fluoroethylene carbonate, and based on a mass of the electrolyte, a mass percentage of fluoroethylene carbonate is E %, wherein 7≤E≤20; or
(3) the electrolyte comprises vinylene carbonate, and based on a mass of the electrolyte, a mass percentage of vinylene carbonate is H %, wherein 0.01≤H≤2.

20. The electronic device according to claim 19, wherein the electrolyte satisfies at least one of the following conditions:
$$0.05 \leq G \leq 0.95 ; \qquad ( 1 )$$
$$10 \leq E \leq 15 ; or \qquad ( 2 )$$
$$0.01 \leq H \leq 0.85 . \qquad ( 3 )$$
